(19) United States
(12) Patent Application Publication
(10) Pub. No.: US 2024/0091094 A1
(43) Pub. Date: Mar. 21, 2024

(54) Adjustable Massage Board

(71) Applicant: Kenneth Tobias, Virginia Beach, VA (US)

(72) Inventor: Kenneth Tobias, Virginia Beach, VA (US)

(21) Appl. No.: 17/946,991

(22) Filed: Sep. 16, 2022

(51) Int. Cl. A61H 7/00

(52) U.S. Cl. CPC A61H 7/002; A61H 2201/0107; A61H 2201/0134; A61H 2201/0192; A61H 2201/1253; A61H 2201/1623; A61H 2205/081

(57) ABSTRACT

An adjustable massage board includes a platform, at least one first opening, at least one second opening, at least one first interlocking arm, at least one second interlocking arm, at least one massaging body. The platform that functions as the base component includes a main body and an outer edge. The at least one first opening and the at least one second opening traverse into the main body from the outer edge. The at least one interlocking arm and the at least one second interlocking arm are outwardly connected to the outer edge. The first opening and/or the second opening can be removably engaged with the first interlocking arm and/or the second interlocking arm to create a modular system. The at least one massaging body is slidably engaged onto the main body through a fastening mechanism.

### FIELD OF THE INVENTION

The present invention relates generally to a massage board. More specifically, the present invention relates to an adjustable massage board that can combined into a modular system of adjustable massage boards.

### BACKGROUND OF THE INVENTION

Back pain is one of the most common types of injury that people suffer from. As a result, various methods and equipment have been developed to relieve back pain. One common method is by applying pressure to trigger points on an individual's back. This can be done by a trained masseuse to relieve pain in an individual's back. However, this requires another individual to be involved. Though there are devices that allow an individual to apply pressure to trigger points by themselves, the devices are not efficient as they do not cover a lot of surface area. Therefore, there needs to be a device that allows a user to apply pressure to a large amount of trigger points on the user's back by themselves. In addition, one size fit all devices are not effective for applying pressure to trigger points as each individual can have their own unique body shape. Therefore, there is a need for an adjustable device that can apply pressure to trigger points based on user preference.

It is an objective of the present invention to provide an adjustable massage board that applies pressure to an individual's back. The present invention allows an individual to apply pressure to a large amount of trigger points on the user's back by themselves. When a plurality of the adjustable massage board is removably mounted to each other, the present invention creates a modular system of adjustable massage boards. The modular system of the present invention can be rearranged to be properly accommodate for an individual. The present invention utilizes slidably massaging bodies which can apply pressure to a user's trigger points when a user lies on top of the present invention, wherein the massaging bodies can be custom molded and rearranged to suit a user's personal preference.

### BRIEF DESCRIPTION OF THE DRAWINGS

FIG. 1 is a to perspective view of the present invention.

FIG. 2 is a bottom view of the present invention.

FIG. 3 is a top view of the present invention.

FIG. 4 is a side view of the present invention, showing the plane upon which a cross sectional view is taken shown in FIG. 5.

FIG. 5 is a cross section view of the present invention taken along line A-A of FIG. 4, showing the fastening mechanism.

FIG. 6 is a view showing the modular system of the present invention.

### DETAIL DESCRIPTIONS OF THE INVENTION

All illustrations of the drawings are for the purpose of describing selected versions of the present invention and are not intended to limit the scope of the present invention.

The present invention is an adjustable massage board that allows an individual to apply pressure to a large amount of trigger points on the user's back by themselves. The present invention can be assembled as a modular system when multiple adjustable massage boards are attached to each other. The modularity of the present invention allows to be resized according to the user preference. For example, one adjustable massage board can be attached to another adjustable massage board to increase the size of available surface area for the user.

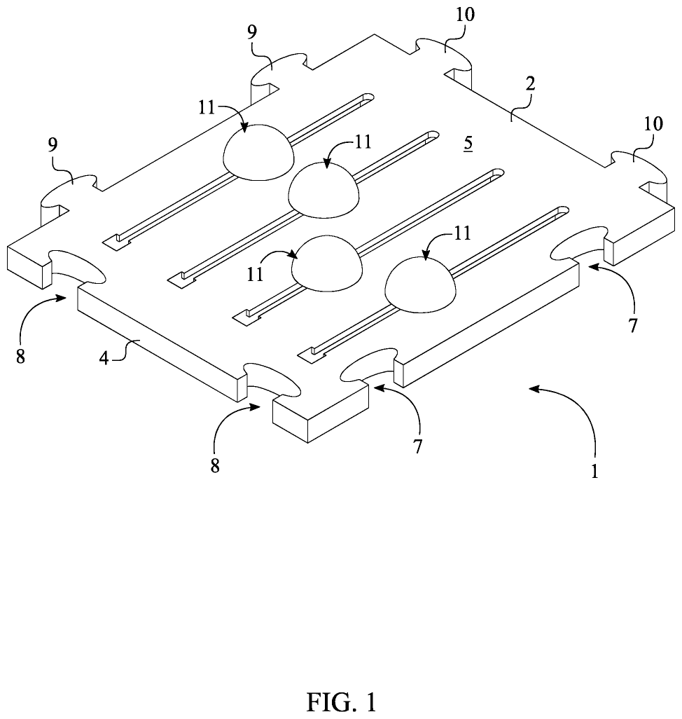

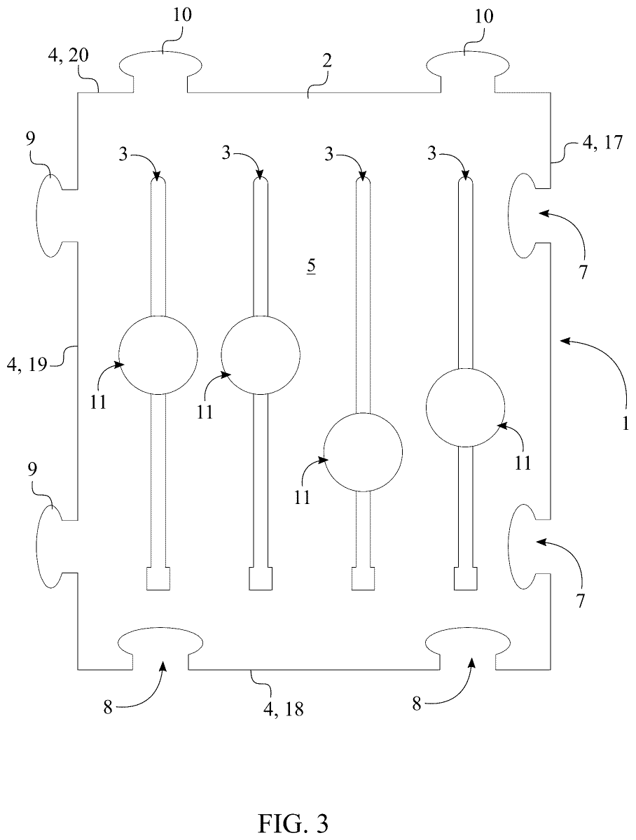

The present invention comprises a platform 1, at least one first opening 7, at least one second opening 8, at least one first interlocking arm 9, at least one second interlocking arm 10, at least one massaging body 11, and a fastening mechanism 14 as shown in FIG. 1. In reference to the general configuration of the present invention, the platform 1 that function as the modular body comprises a main body 2 and an outer edge 4. As can be seen in FIG. 3, the outer edge 4 comprises a first lengthwise edge 17, a second lengthwise edge 18, a first widthwise edge 19, and a second widthwise edge 20. The at least one first opening 7 and the at least one second opening 8 traverses into the main body 2 from the outer edge 4, wherein the at least one first opening 7 and the at least one second opening 8 are defined into indentations. More specifically, the at least one first opening 7 traverses into the main body 2 from the first lengthwise edge 17, and the at least one second opening 8 traverses into the main body 2 from the first widthwise edge 19. The at least one first interlocking arm 9 and the at least one second interlocking arm 10 are outwardly connected to the outer edge 4, wherein the at least one first interlocking arm 9 and the at least one second interlocking arm 10 are defined as matching protrusions to the indentations. More specifically, the at least one first interlocking arm 9 is outwardly connected to the second lengthwise edge 18, and the at least one second interlocking arm 10 is outwardly connected to the second widthwise edge 20. The at least one massaging body 11 that applies pressure to the user's trigger points is slidably engaged onto the main body 2 through the fastening mechanism 14 so that the user can easily adjust the positioning of the at least one massaging body 11 within the platform 1. Furthermore, a plurality of massage boards can be attached to each other through the at least one first opening 7, the at least one second opening 8, the at least one first interlocking arm 9, and the at least one second interlocking arm 10. More specifically, the at least one first opening 7 and/or the at least one second opening 8 of an arbitrary board from the plurality of massage boards can be attached with the least one first interlocking arm 9 and/or the at least one second interlocking arm 10 of an adjacent board from the plurality of massage boards.

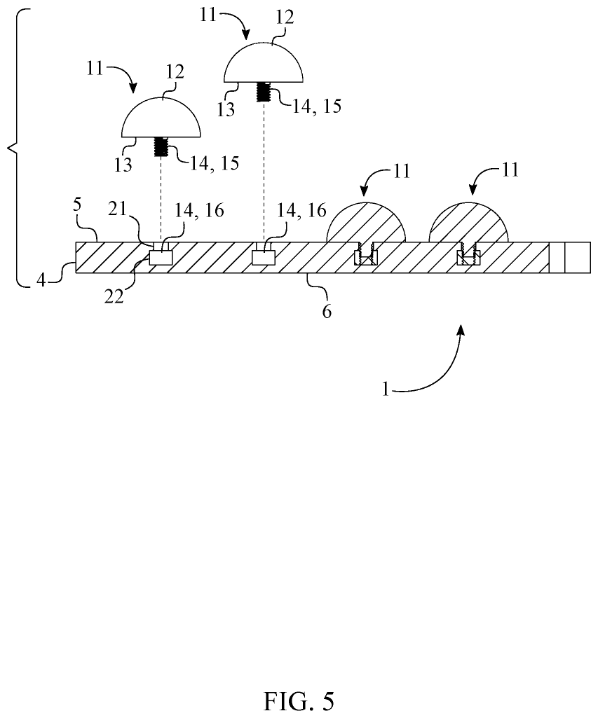

In reference to FIG. 1 and FIG. 5, the platform 1 is preferably formed into a rectangular-like shape. However, it is known that the platform 1 is not limited to the rectangular-like shape and can be any other geometric or organic shape. The platform 1 is a rigid body so that the at least one massaging body 11 can orient normal to a top surface of main body 2. Furthermore, a bottom surface 6 of the main body 2 is a flat surface so that the platform 1 can be stably positioned atop the ground floor, without any swaying movement. The outer edge 4 is the parameter of the platform 1 as the shape of the platform 1 is delineated by the outer edge 4.

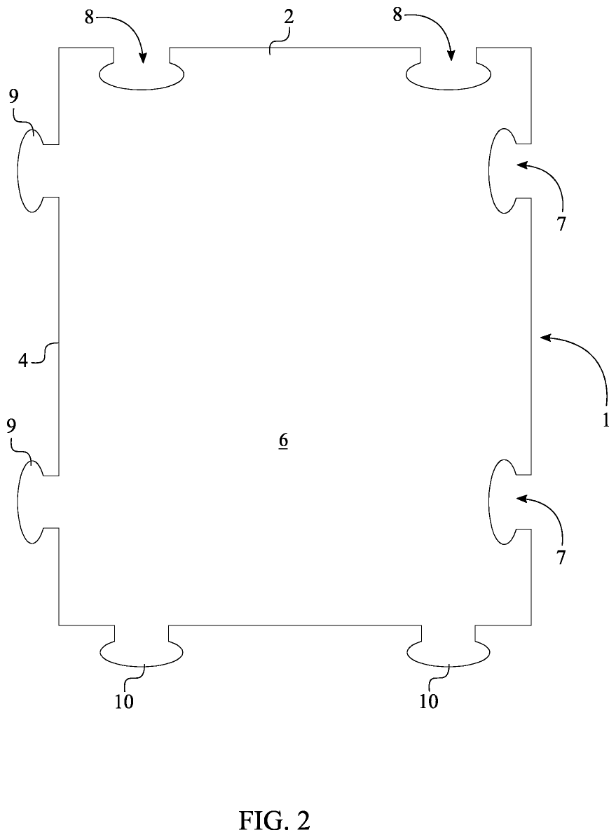

In reference to FIGS. 1-3, the at least one first opening 7 and the at least one second opening 8 are inwardly traversed into the main body 2 from the outer edge 4. The at least one first interlocking arm 9 and the at least one second interlocking arm 10 are connected to the outer edge 4 and outwardly oriented from the main body 2. In order to accommodate the modular system of the present invention, the shape of the at least one first opening 7 and the at least one second opening 8 matches to the shape of the at least one first interlocking arm 9 and the at least one second interlocking arm 10. For example, when the at least one first opening 7 and the at least one second opening 8 are formed into rectangular openings, the at least one first interlocking arm 9 and the at least one second interlocking arm 10 are also formed into matching rectangular protrusions that interlock within the rectangular openings. Furthermore, a surface area for the at least one first opening 7 and the at least one second opening 8 of the arbitrary board are slightly larger than a surface area for the at least one first interlocking arm 9 and the at least one second interlocking arm 10 of the arbitrary board, wherein the size difference provides necessary tolerance to attach the adjustable board.

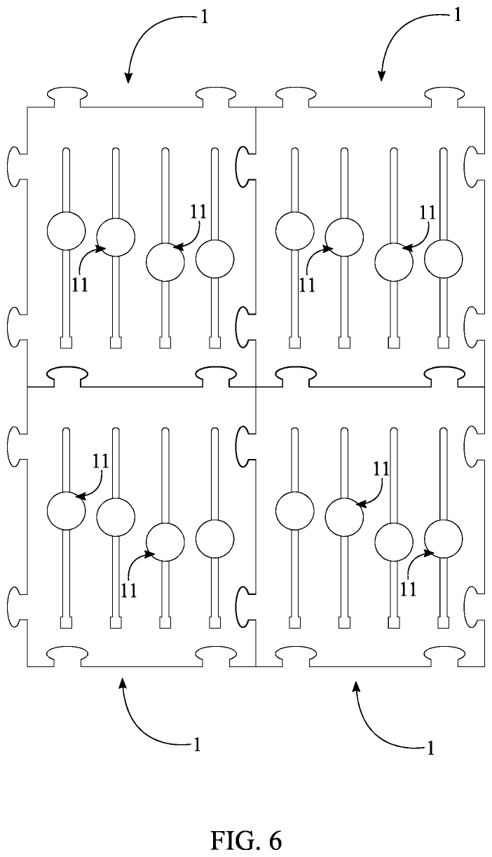

In reference to FIG. 1 and FIGS. 3-6, the at least one massaging body 11 applies pressure to the trigger points on a user's back when the user is lying on the present invention. More specifically, the at least one massaging body is a cushion body so that the applied pressure can be distributed throughout the surface area of the cushion body. In reference to FIG. 5, the at least one massaging body 11 is formed into a hemispherical shape and comprises a hemispherical surface 12 and a base surface 13. More specifically, a largest circular edge of the hemispherical surface 12 is perimetrically connected around the base surface 13 and oriented outward from the top surface 5. Resultantly, the base surface 13 is positioned parallel and adjunct to the top surface 5 of the main body 2.

In reference to FIG. 3, the present invention further comprises at least one channel 3 that allows the slidable engagement of the at least one massaging body 11. More specifically, the at least one channel 3 traverses into the main body 2 from the top surface 5 of the main body 2 as the at least one channel 3 is positioned within the outer edge 4. The at least one channel 3 is also positioned offset from a bottom surface 6 of the main body 2, and the at least one channel 3 is positioned parallel to the first lengthwise edge 17 and the second lengthwise edge 18. The shape of the at least one channel 3 can differ according to the shape of the main body 2 without deviating from the scope of the functionality. It is also understood that the at least one channel 3 can be any number of channels within the main body 2. The at least one massaging body 11 is slidably engaged within the at least one channel 3 through the fastening mechanism 14 so that the user can adjust the positioning of the at least one massaging body 11 along the at least one channel 3. In the preferred embodiment of the present invention, the main body 2 has four channels wherein each channel receives the at least one massaging body 11 that can slide.

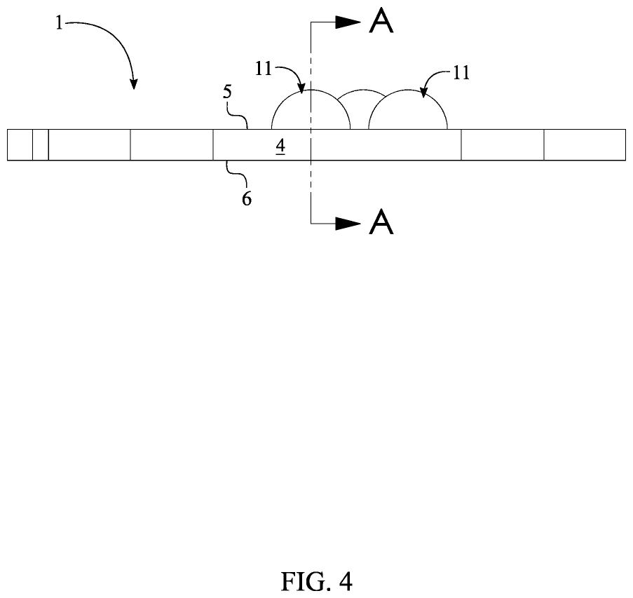

In reference to FIG. 4 and FIG. 5, the fastening mechanism 14 preferably comprising a male fastener 15 and a female fastener 16 so that the at least one massaging body 11 can be removably engaged within the at least one channel 3. Moreover, a transversal cross section of the at least one channel 3 is a narrower section 21 and a wider section 22. The narrower section 21 intersects the top surface 5 of the main body 2, and the wider section 2 is positioned adjacent to the narrower section 21, opposite to the top surface 5 of the main body 2. The male fastener 15 is adjacently connected to the at least one massaging body 11 and is positioned through the narrower section 21 so that the male fastener 15 can be inserted into the at least one channel 3. More specifically, the male fastener 15 is concentrically connected onto the base surface 13 and oriented normal to the base surface 13. The female fastener 16 is slidably engaged within the wider section 22. As a result, the male fastener 15 can be threadably attached to the female fastener 16 thus allowing the at least one massaging body 11 to freely slide along the at least one channel 3.

Optionally, the fastening mechanism 14 can be a magnetic fastening system that comprises a first magnetic fastener and a second magnetic fastener. More specifically, the magnetic fastener is integrated into the top surface 5 of the main body 2 and the second magnetic fastener is integrated into the base surface 13 of the at least one massaging body 11 thus allowing the at least one massaging body 11 to be magnetically attached to the platform 1. Furthermore, the magnetic attraction between the main body 2 and the at least one massaging body 11 provides sufficient force so that the user can easily move around the at least one massaging body 11 along the top surface 5. When the fastening mechanism 14 is a magnetic fastening system, the present invention does not require at least one channel 3 that guides the movement of the at least one massaging body 11. As a result, the at least one massaging body 11 can freely slide anywhere within the top surface 5 as the movement of the at least one massaging body 11 is not restricted.

Although the invention has been explained in relation to its preferred embodiment, it is to be understood that many other possible modifications and variations can be made without departing from the spirit and scope of the invention as hereinafter claimed.

1. An adjustable massage board comprising:
a plurality of massage-board units;
each of the plurality of massage-board units comprising a platform, at least one first opening, at least one second opening, at least one first interlocking arm, at least one second interlocking arm, at least one massaging body, and at least one fastening mechanism;
the platform comprising a main body and an outer edge;
the outer edge comprising a first lengthwise edge, a second lengthwise edge, a first widthwise edge, and a second widthwise edge;
the at least one first opening traversing into the main body from the first lengthwise edge;
the at least one second opening traversing into the main body from the first widthwise edge;
a thickness of the at least one first opening and a thickness of the at least one second opening being equal to a thickness of the main body;
the at least one first interlocking arm being outwardly connected to the second lengthwise edge;
the at least one second interlocking arm being outwardly connected to the second widthwise edge;
a thickness of the at least one first interlocking arm and a thickness of the at least one second interlocking arm being equal to the thickness of main body;
a surface area enclosed by an elliptically-shaped concave perimeter of the at least one first opening being larger by a tolerance gap than a surface area enclosed by an elliptically-shaped convex perimeter of the at least one first interlocking arm;
a surface area enclosed by an elliptically-shaped concave perimeter of the at least one second opening being larger by a tolerance gap than a surface area enclosed by an elliptically-shaped convex perimeter of the at least one second interlocking arm;
the at least one massaging body being slidably engaged onto the main body through the at least one fastening mechanism;
the at least one first interlocking arm for an arbitrary unit engaging the at least one first opening for a first adjacent unit, wherein the arbitrary unit and the first adjacent unit is any pair of units from the plurality of massage-board units; and
the at least one second interlocking arm for the arbitrary unit engaging the at least one second opening for a second adjacent unit, wherein the arbitrary unit and the second adjacent unit is also any pair of units from the plurality of massage-board units.

2. The adjustable massage board as claimed in claim 1, wherein the platform is a rigid body.

3. The adjustable massage board as claimed in claim 1, wherein the at least one massaging body is a cushion body.

4. The adjustable massage board as claimed in claim 1, wherein a bottom surface of the main body is a flat surface.

5. The adjustable massage board as claimed in claim 1 comprising:
each of the plurality of massage-board units comprising further at least one channel;
the at least one channel traversing into the main body from a top flat surface of the main body;
the at least one channel being positioned offset from a bottom surface of the main body;
the at least one channel being positioned within the outer edge;
the at least one channel being positioned parallel to the first lengthwise edge and the second lengthwise edge;
the at least one massaging body being slidably engaged within the at least one channel through the at least one fastening mechanism;
the at least one channel for each of the plurality of massage-board units being positioned parallel to each other; and
the at least one channel for the arbitrary unit being positioned collinear to the at least one channel for the second adjacent unit.

6. The adjustable massage board as claimed in claim 5 comprising:
the at least one fastening mechanism comprising a male fastener and a female fastener;
a transversal cross section of the at least one channel comprising a narrower section and a wider section;
the narrower section intersecting the top flat surface of the main body;
the wider section being positioned adjacent to the narrower section, opposite to the top flat surface of the main body;
the male fastener being adjacently connected to the at least one massaging body;
the female fastener being slidably engaged within the wider section;
the male fastener being positioned through the narrower section; and
the male fastener being threadably attached to the female fastener.

7. The adjustable massage board as claimed in claim 1 comprising:
the at least one massaging body comprising a hemispherical surface and a base surface;
a largest circular edge of the hemispherical surface being perimetrically connected around the base surface; and
the base surface being positioned parallel to a top flat surface of the main body.

8. An adjustable massage board comprising:
a plurality of massage-board units;
each of the plurality of massage-board units comprising a platform, at least one first opening, at least one second opening, at least one first interlocking arm, at least one second interlocking arm, at least one massaging body, at least one fastening mechanism, and at least one channel;
the platform comprising a main body and an outer edge;
the at least one fastening mechanism comprising a male fastener and a female fastener;
a transversal cross section of the at least one channel comprising a narrower section and a wider section;
the outer edge comprising a first lengthwise edge, a second lengthwise edge, a first widthwise edge, and a second widthwise edge;
the at least one first opening traversing into the main body from the first lengthwise edge;
the at least one second opening traversing into the main body from the first widthwise edge;
a thickness of the at least one first opening and a thickness of the at least one second opening being equal to a thickness of the main body;
the at least one first interlocking arm being outwardly connected to the second lengthwise edge;
the at least one second interlocking arm being outwardly connected to the second widthwise edge;
a thickness of the at least one first interlocking arm and a thickness of the at least one second interlocking arm being equal to the thickness of main body;
a surface area enclosed by an elliptically-shaped concave perimeter of the at least one first opening being larger by a tolerance gap than a surface area enclosed by an elliptically-shaped convex perimeter of the at least one first interlocking arm;
a surface area enclosed by an elliptically-shaped concave perimeter of the at least one second opening being larger by a tolerance gap than a surface area enclosed by an elliptically-shaped convex perimeter of the at least one second interlocking arm;
the at least one massaging body being slidably engaged onto the main body through the at least one fastening mechanism;
the at least one massaging body being a cushion body;
the at least one channel traversing into the main body from a top flat surface of the main body;
the at least one channel being positioned offset from a bottom surface of the main body;
the at least one channel being positioned within the outer edge;
the at least one channel being positioned parallel to the first lengthwise edge and the second lengthwise edge;
the at least one massaging body being slidably engaged within the at least one channel through the at least one fastening mechanism;
the narrower section intersecting the top flat surface of the main body;
the wider section being positioned adjacent to the narrower section, opposite to the top flat surface of the main body;
the male fastener being adjacently connected to the at least one massaging body;
the female fastener being slidably engaged within the wider section;
the male fastener being positioned through the narrower section;
the male fastener being threadably attached to the female fastener;
the at least one first interlocking arm for an arbitrary unit engaging the at least one first opening for a first adjacent unit, wherein the arbitrary unit and the first adjacent unit is any pair of units from the plurality of massage-board units;
the at least one second interlocking arm for the arbitrary unit engaging the at least one second opening for a second adjacent unit, wherein the arbitrary unit and the second adjacent unit is also any pair of units from the plurality of massage-board units;
the at least one channel for each of the plurality of massage-board units being positioned parallel to each other; and
the at least one channel for the arbitrary unit being positioned collinear to the at least one channel for the second adjacent unit.

9. The adjustable massage board as claimed in claim 8, wherein the platform is a rigid body.

10. The adjustable massage board as claimed in claim 8, wherein the bottom surface of the main body is a flat surface.

11. (canceled)

12. (canceled)

13. The adjustable massage board as claimed in claim 8 comprising:
the at least one massaging body comprising a hemispherical surface and a base surface;
a largest circular edge of the hemispherical surface being perimetrically connected around the base surface; and
the base surface being positioned parallel to the top flat surface of the main body.

14. An adjustable massage board comprising:
a plurality of massage-board units;
each of the plurality of massage-board units comprising a platform, at least one first opening, at least one second opening, at least one first interlocking arm, at least one second interlocking arm, at least one massaging body, at least one fastening mechanism, and at least one channel;
the platform comprising a main body and an outer edge;
the at least one massaging body comprising a hemispherical surface and a base surface;
the at least one fastening mechanism comprising a male fastener and a female fastener;
a transversal cross section of the at least one channel comprising a narrower section and a wider section;
the outer edge comprising a first lengthwise edge, a second lengthwise edge, a first widthwise edge, and a second widthwise edge;
the at least one first opening traversing into the main body from the first lengthwise edge;
the at least one second opening traversing into the main body from the first widthwise edge;
a thickness of the at least one first opening and a thickness of the at least one second opening being equal to a thickness of the main body;
the at least one first interlocking arm being outwardly connected to the second lengthwise edge;
the at least one second interlocking arm being outwardly connected to the second widthwise edge;
a thickness of the at least one first interlocking arm and a thickness of the at least one second interlocking arm being equal to the thickness of main body;
a surface area enclosed by an elliptically-shaped concave perimeter of the at least one first opening being larger by a tolerance gap than a surface area enclosed by an elliptically-shaped convex perimeter of the at least one first interlocking arm;
a surface area enclosed by an elliptically-shaped concave perimeter of the at least one second opening being larger by a tolerance gap than a surface area enclosed by an elliptically-shaped convex perimeter of the at least one second interlocking arm;
a largest circular edge of the hemispherical surface being perimetrically connected around the base surface;
the base surface being positioned parallel to a top flat surface of the main body;
the at least one massaging body being slidably engaged onto the main body through the at least one fastening mechanism;
the at least one massaging body being a cushion body;
the at least one channel traversing into the main body from a top flat surface of the main body;
the at least one channel being positioned offset from a bottom surface of the main body;
the at least one channel being positioned within the outer edge;
the at least one channel being positioned parallel to the first lengthwise edge and the second lengthwise edge;
the at least one massaging body being slidably engaged within the at least one channel through the at least one fastening mechanism;
the narrower section intersecting the top flat surface of the main body;
the wider section being positioned adjacent to the narrower section, opposite to the top flat surface of the main body;
the male fastener being adjacently connected to the at least one massaging body;
the female fastener being slidably engaged within the wider section;
the male fastener being positioned through the narrower section;
the male fastener being threadably attached to the female fastener;
the at least one first interlocking arm for an arbitrary unit engaging the at least one first opening for a first adjacent unit, wherein the arbitrary unit and the first adjacent unit is any pair of units from the plurality of massage-board units;
the at least one second interlocking arm for the arbitrary unit engaging the at least one second opening for a second adjacent unit, wherein the arbitrary unit and the second adjacent unit is also any pair of units from the plurality of massage-board units;
the at least one channel for each of the plurality of massage-board units being positioned parallel to each other; and
the at least one channel for the arbitrary unit being positioned collinear to the at least one channel for the second adjacent unit.

15. The adjustable massage board as claimed in claim 14, wherein the platform is a rigid body.

16. The adjustable massage board as claimed in claim 14, wherein the bottom surface of the main body is a flat surface.

17. (canceled)

18. (canceled)
